(19) United States
(12) Patent Application Publication
(10) Pub. No.: US 2014/0297054 A1
(43) Pub. Date: Oct. 2, 2014

(54) POWER CONTROL DEVICE AND METHOD OF CONTROLLING POWER

(71) Applicant: HON HAI PRECISION INDUSTRY CO., LTD., New Taipei (TW)

(72) Inventor: JUI-CHE TSAI, New Taipei (TW)

(73) Assignee: HON HAI PRECISION INDUSTRY CO., LTD., New Taipei (TW)

(21) Appl. No.: 14/201,952

(22) Filed: Mar. 10, 2014

(30) Foreign Application Priority Data
Mar. 29, 2013 (TW) 102111566

(51) Int. Cl. H02J 4/00

(52) U.S. Cl. CPC H02J 4/00
USPC 700/295

(57) ABSTRACT

A power control device used for controlling power includes a table generating module, a detecting module, a timing module, a table search module, a determining module, a controlling module, a storage system and a processor. The table generating module is used to generating a relationship table. The detecting module is used to receive a disconnected message of the ports and the wireless transmitting units. The timing module is used to measure the disconnected time of the wireless transmitting units. The table search module is used to search personal electrical equipment from the relationship table. The determining module makes determination according to the disconnected message. The controlling module controls the electrical equipment.

### BACKGROUND

1. Technical Field

Embodiments of the present disclosure generally relate to power controlling, and more particularly to a power control device and a power controlling method of the power control device.

2. Description of Related Art

Large offices often have a large number of electrical equipment, and controlling the power of the electrical equipment can be difficult. For example, when people leave the office, a specialized person is usually designated to check if all electrical equipment has been turned off, resulting in a waste of electricity, and increasing manpower costs. Thus, a method of controlling power of the electrical equipment, and a power control device implementing such method is needed.

### BRIEF DESCRIPTION OF THE DRAWINGS

FIG. 1 is a schematic diagram of one embodiment of an application environment of a power control device.

FIG. 2 is a detail schematic diagram of an application environment of the power control device 200 corresponding to FIG. 1

FIG. 3 is a schematic diagram of one embodiment of functional modules of the power control device 200.

FIG. 4 is a relationship table representing a relationship between the plurality of personal electrical equipment, the plurality of ports of the network switch, and the plurality of wireless transmitting units.

FIG. 5 is a flowchart of one embodiment of a power controlling method employed by the power control device 200.

FIG. 6 is a flowchart of details of FIG. 5.

### DETAILED DESCRIPTION

The embodiments are illustrated by way of example and not by way of limitation in the figures of the accompanying drawings in which like references numerals indicate similar elements. It should be noted that references to “an” or “one” embodiment in this disclosure are not necessarily to the same embodiment, and such references can mean “at least one.”

In general, the word “module” as used hereinafter refers to logic embodied in hardware or firmware, or to a collection of software instructions, written in a programming language such as, for example, Java, C, or assembly. One or more software instructions in the modules can be embedded in firmware such as in an erasable-programmable read-only memory (EPROM). It will be appreciated that the modules can comprise connected logic units, such as gates and flip-flops, and can comprise programmable units, such as programmable gate arrays or processors. The modules described herein can be implemented as either software and/or hardware modules and can be stored in any type of computer-readable medium or other computer storage device.

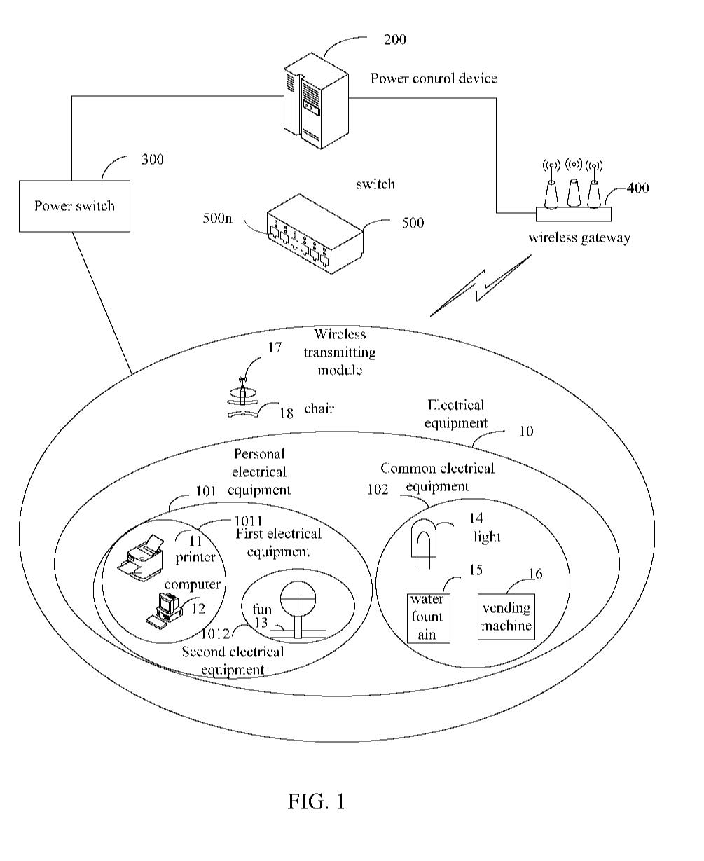

FIG. 1 is a schematic diagram of one embodiment of an application environment of a power control device 200. The power control device 200 can be used in an environment in which the controlling of electrical equipment 10 is needed, such as offices or homes. In the present embodiment, an office is described as an example.

In the office, such as shown in FIG. 1, there are a variety of electrical equipment 10 such as printers 11, computers 12, fans 13, and lights 14. Each office has electrical equipment 10 in personal areas and common areas. The electrical equipment 10 located in the personal areas is defined as the personal electrical equipment 101, and electrical equipment 10 located in common areas is defined as the common electrical equipment 102. For example, a printer 11, computer 12, and fans 13 should be personal electrical equipment 101, while the lights 14, the water fountain 15, and the vending machine 16 can be classified as the common electrical equipment 102. The electrical equipment 10 is not limited to the electrical equipment in FIG. 1.

FIG. 1 also includes a power switch 300, a wireless gateway 400, and a switch 500. The power switch 300 is used to control power to the electrical equipment 10, such as power to the personal electrical equipment 101 and the common electrical equipment 102. The wireless gateway 400 is used to connect wireless transmission units 17. Each wireless transmission unit 17 is set on one chair 18 of the personal area and is able to detect when someone sits on the chair 18. If someone is sitting on the chair, the transmission unit 17 is turned on, then the transmission unit 17 will send a radio signal. When the person leaves the chair 18, the transmission unit 17 is turned off, and the transmission unit 17 stops sending the radio signal. The switch 500 has a number of ports 500n used to connect electrical equipment 10 to the internet. In the embodiment, the electrical equipment 10 connected to the switch are called the first electrical equipment 1011, such as the printer 11 and the computer 12. The other personal electrical equipment 10 is called the second equipment 1012 such as the fans 13.

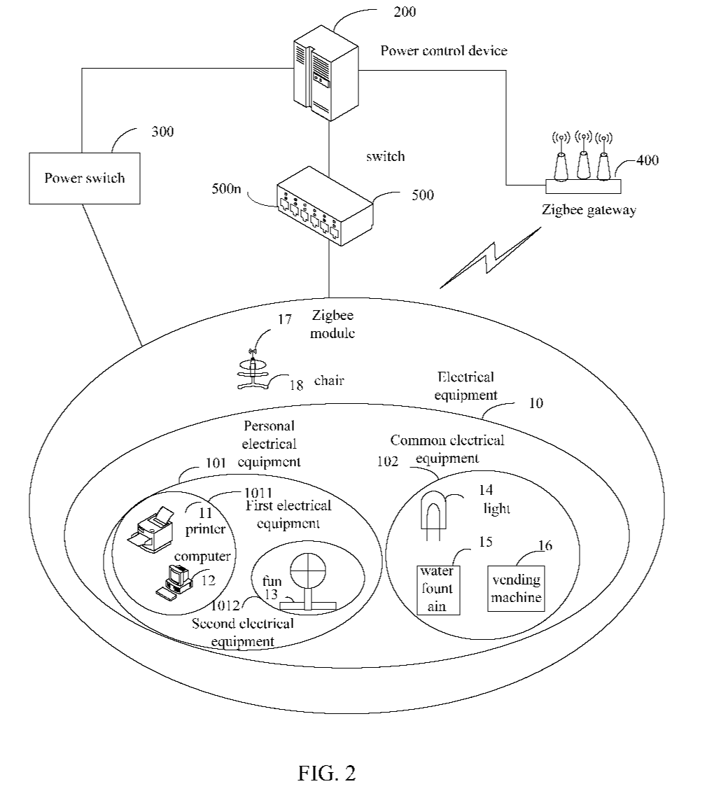

FIG. 2 is a detailed schematic diagram of an application environment of the power control device 200 corresponding to FIG. 1. In wireless technology terms, the ZigBee energy consumption is low, and can support a large number of net nodes, so ZigBee energy can be used as a wireless transmitting unit 17. In other embodiments, other techniques can be used to detect if a person is using the chair 18, such as human body sensors and cameras. The wireless transmission units 17 can be ZigBee modules 171, and a wireless gateway 400 can be a ZigBee Gateway 4001.

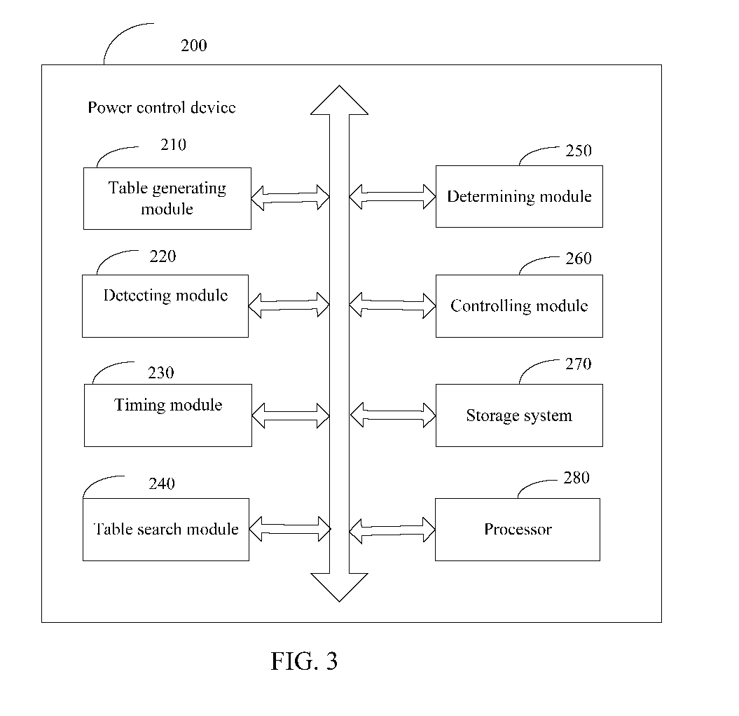

FIG. 3 is a schematic diagram of one embodiment of functional modules of the power control device 200. The power control device 200 comprises a table generating module 210, a detecting module 220, a timing module 230, a table search module 240, a determining module 250, a controlling module 250, a storage system 260, and a processor 270.

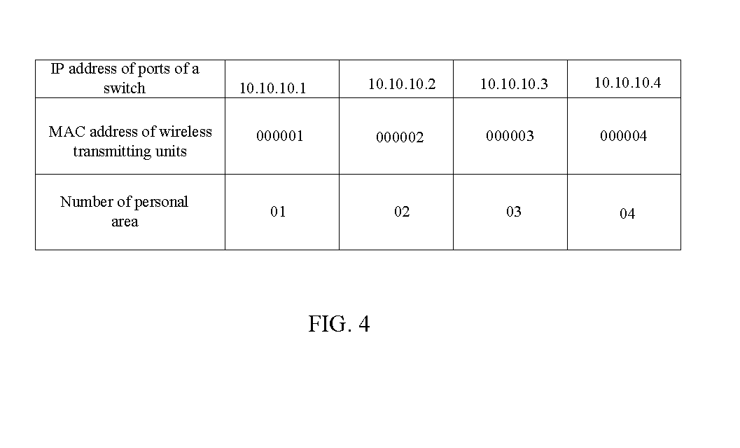

The table generating module 210 generates a relationship table as shown in FIG. 4, the table contains internet protocol (IP) address of the ports 500n, numbers of the personal areas, and the media access control (MAC) address of the ZigBee modules 171. As shown in FIG. 4, the IP address of the ports 500n can uniquely present corresponding ports of the network switch 500, such as 10.10.10.1, 10.10.10.2, and so on. The numbers of the personal areas represent a variety of private areas that contains a plurality of electrical equipment 10. Meanwhile, the MAC address of the ZigBee modules 171 uniquely represents the ZigBee modules 171, such as 00001, 00002, and so on. In the present embodiment, one personal area has only one IP address and one MAC address, so the power control device 200 can monitor personal electrical equipment 101 located in the personal area according to the relationship table generated by the table generating module.

The detecting module 220 receives a port disconnecting message from the network switch 500 that indicates disconnection of the plurality of the ports 500n. In the present information, the switch 500 has many ports used to connect with the first electrical equipment 1011 of the personal area, such as the printer 11 or computer 12. The port disconnecting message comprises the IP address of the ports 500n which are disconnected. The detecting module 230 can then find the ports 500n from the relationship table.

The detecting module 230 also receives a wireless disconnecting message from the ZigBee gateway that indicates disconnection of the plurality of the ZigBee modules. Once the wireless disconnecting message of the ZigBee modules 171 has been received, the timing module 230 measures the disconnecting time of the ZigBee modules 171 and determines whether the disconnecting time of the ZigBee modules 171 is higher than a default disconnecting time. In the embodiment, if the ZigBee modules 171 have been disconnected, then the ZigBee gateway 4001 will not receive the radio signal which is sent by the ZigBee modules 171, the wireless disconnecting message of the ZigBee modules 171 comprises the MAC address of the ZigBee modules 171 which are disconnecting, then the detecting module 230 can find the ZigBee modules 171 which are disconnected from the relationship table. Meanwhile, the default can be set at 1 hour or any other value based on need.

The table search module 240 searches the relationship table to obtain the personal electrical equipment 101 corresponding to the disconnecting ports 500n of the switch 500 and the disconnecting ZigBee modules 171 according to the port disconnecting message and the wireless disconnecting message. In the present embodiment, the relationship presents a relationship between the plurality of the personal electrical equipment 101, the plurality of the ports 500n of the switch 500, and the plurality of the ZigBee modules 171. Therefore, the personal electrical equipment 101 corresponding to the disconnecting ports 500n of the switch 500 and the disconnecting ZigBee modules 171 can easily to be obtained.

The determining module 250 determines whether all wireless transmitting units are disconnected according to the wireless disconnecting message and the relationship table, determines whether all the ports of the network switch are disconnected according to the port disconnecting message and the relationship table, and determines whether all the disconnecting times are greater than the default.

The control module 260 controls the power switch 300 to cut off power to all electrical equipment 10. In the present embodiment, if someone is in their personal area, the personal electrical equipment 101 and the common electrical equipment 102 are not turned off, so once all ZigBee modules 171 are disconnected, all the disconnect times of the ZigBee modules 171 are greater than the default, and all ports 500n of the switch 500 are disconnected, the control module 240 will control the power switch to cut off power to all the electrical equipment 10. If all ZigBee modules 171 are disconnected, and all the disconnect times of the ZigBee modules 171 are greater than the default, but there are some switch ports 500n which are connected, the control module 240 keeps the first electrical equipment 1011 corresponding to the ports 500n which are connected turned on, and controls the power switch 300 to cut off power to all other electrical equipment 10. If only some of the ZigBee modules 171 are disconnected and the disconnecting time of the ZigBee module 171 is greater than the default, the ports 500n of the switch 500 corresponding to the disconnecting ZigBee modules 171 whose disconnecting times are greater than the default are disconnected. The control module 240 controls the power switch 300 to cut off power to the personal electrical equipment 101 corresponding to the ZigBee modules 171 whose disconnecting time are greater than the default, and the controlling module 240 keeps other electrical equipment 10 turned on. If some ZigBee modules 171 are disconnected and the disconnecting time of the ZigBee modules 171 is greater than the default, but the corresponding ports 500n of the switch 500 have not disconnected, the control module 240 controls the power switch 300 to cut off power to the second equipment 1012 corresponding to the ZigBee modules 171 whose disconnecting time are greater than the default, and the other electrical equipment 10 remains turned on. If none of ZigBee modules 171 are disconnected or the disconnecting time of the ZigBee modules 171 are all less than the default, the control module 240 keeps all electrical equipment 10 turned on.

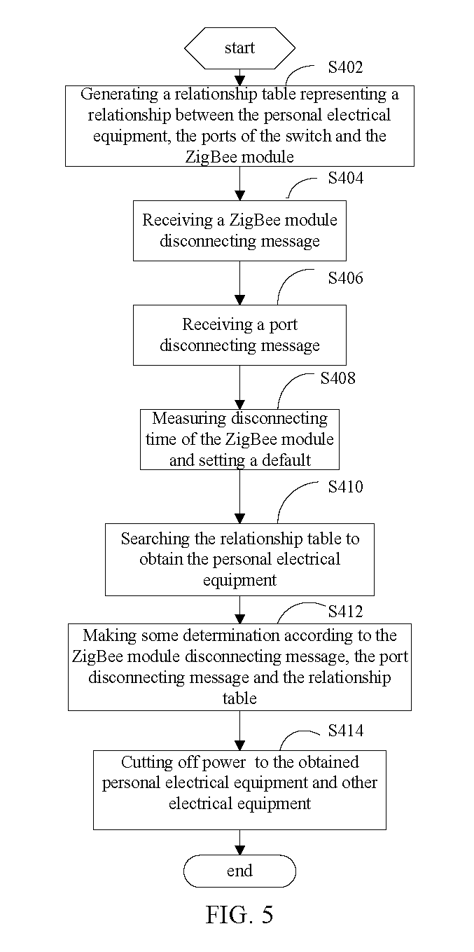

FIG. 5 is a flowchart of an embodiment of a method of controlling power, the method is employed by the power control device 200. In the embodiment, the method is implemented in the application environment shown in FIG. 2 in the following manner.

In block S402, the table generating module 210 generates a relationship table containing IP address of the ports 500n, numbers of the personal area, and the MAC address of the ZigBee modules 171. The number of the personal area represents the personal area containing the electrical equipment 10, therefore, the relationship table represents the relationship between the personal electrical equipment 101, the ports 500n of the switch, and the ZigBee module 171.

In block S404, the detecting module 220 receives the ZigBee module disconnected message from the ZigBee gateway 400 that indicates disconnection of the the ZigBee modules 171. In the present embodiment, each of the ZigBee modules 171 is set in one chair 18, so that when someone sits on the chair 18, the ZigBee module 171 is turned on, and the ZigBee gateway 4001 can receive the radio signal which is sent by the ZigBee module 171. When the person leaves the chair 18, the ZigBee module 171 is turned off, and the ZigBee gateway 4001 cannot receive the radio signal sent by the ZigBee module 171. Thus, the ZigBee gateway 4001 can determine whether the person have left the chair 18 according to the disconnect message. The ZigBee module disconnect message from the ZigBee gateway 400 comprises the MAC address of the ZigBee modules 171 which are disconnected. The detecting module 230 can then find the ZigBee modules 171 which are disconnected from the relationship table.

In block S406, the detecting module 220 receives a port disconnect message from the network switch 500 that indicates disconnection of the plurality of the ports 500n. In the present embodiment, when the first electrical equipment 1011 connected with the ports 500n of the switch 500 is turned off or sleeping, the switch 500 can detect the disconnect message of the ports 500n quickly and send the disconnect message to the detecting module 230. The port disconnect message from the network switch 500 comprises the IP address of the ports 500n which are disconnected.

In block S408, the timing module 230 measures the disconnect time of the wireless transmitting units and sets a default. In the present embodiment, the default is 1 hour.

In block S410, the table searching module 240 searches the relationship table to obtain the personal electrical equipment 101 corresponding to the disconnected ports 500n of the switch 500 and the disconnected ZigBee modules 171 according to the port disconnect message and the wireless disconnect message. In the present embodiment, the relationship presents a relationship between the plurality of the personal electrical equipment 101, the plurality of the ports 500n of the switch 500, and the plurality of the ZigBee modules 171, so the personal electrical equipment 101 corresponding to the disconnected ports 500n of the switch 500 and the disconnected ZigBee modules 171 can be easily obtained.

In block S412, the determining module 250 makes some determinations according to the ZigBee module disconnect message, the port disconnect message, and the relationship table. In the illustrated embodiment, the determining module 250 determines whether all ZigBee modules 171 have been disconnected according to the wireless disconnect message and the relationship table, determines whether all the ports of the network switch 500 are disconnected according to the port disconnect message and the relationship table, and determines whether all the disconnected times are greater than the default disconnect times.

In block S414, the controlling module 240 controls the power switch 300 to cut off power to the personal electrical equipment 101 and other electrical equipment 10 based on the result of the determination of the determining module 250.

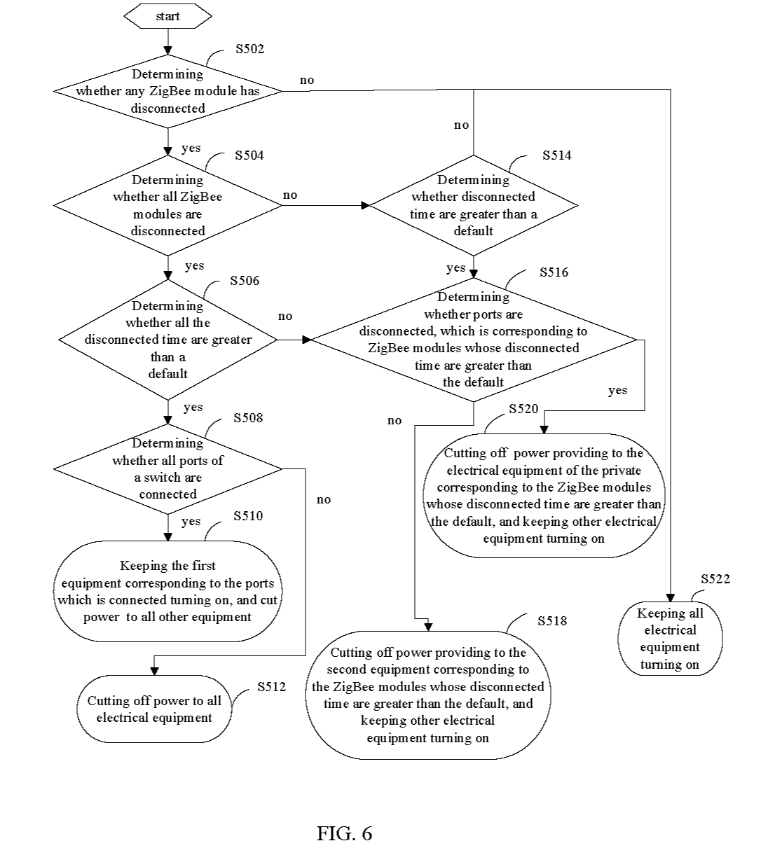

FIG. 6 is a flowchart of details of FIG. 4. In block S502, the controlling module 240 determines whether any ZigBee modules 171 are disconnected according to the wireless disconnect message from the ZigBee gateway 4001 and the relationship table generated by the table generating module 210. In the relationship table, each ZigBee module 171 has only one MAC address, so the personal area, which has the disconnected ZigBee modules 171 can be found from the relationship table, and the personal electrical equipment 101 can be controlled.

In block S504, the controlling module 240 determines whether all ZigBee modules 171 have been disconnected. When all ZigBee modules 171 are disconnected, in block S506, the timing module 220 compares all the disconnected times of the ZigBee modules 171 and the default disconnect times, and determines whether all the disconnected times of the ZigBee module 171 are greater than the default. In the present embodiment, the default is 1 hour, and if the disconnected time of the ZigBee modules 171 is less than 1 hour, it determines that a person has left the chair 18 for only a short time. However, if the disconnected times of the ZigBee modules 171 are greater than 1 hour, it determines that the person has left the office.

When all the disconnected times of the ZigBee modules 171 are greater than the default, in block S508, the controlling module 230 determines whether all the ports 500n of the switch 500 are disconnected.

When only some ports 500n of the switch 500 are disconnected and some ports 500n are connected, in block S510, the controlling module 240 keeps the first electrical equipment 1011 corresponding to the connecting ports 500n turned on, such as the printer 11 and the computer 12, and controls the power switch 300 to cut power to all other electrical equipment 10. When all the ports 500n have been disconnected, the controlling module 240 controls the power switch 300 to cut power to all the electrical equipment 10.

In block S502, the controlling module 240 determines whether any of the ZigBee modules 171 are disconnected. When none of the ZigBee modules 171 are disconnected, then no one has left the office, so the electrical equipment 10 does not need to be controlled, and in block S522, the controlling module 240 keeps all the electrical equipment 10 turned on.

In block S504, when not all of the ZigBee modules 171 are disconnected, in block S514, the timing module 220 determines whether the disconnected times of the disconnected ZigBee modules 171 are higher than the default.

When the disconnecting time of the disconnected ZigBee modules 171 are all less than the default, in block S522, the controlling module 240 keeps all the electrical equipment 10 turned on.

When the disconnected times of the disconnecting ZigBee module 171 are greater than the default, in block S516, the controlling module 240 determines whether the ports 500n of the switch 500 are disconnected. The ports 500n correspond to the disconnected ZigBee modules 171 whose disconnected times are greater than the default.

When the ports 500n of the switch 500 are disconnected, the ports 500n of the switch 500 correspond to the disconnected ZigBee module 171 whose disconnected times are higher than the default. In block S520, the controlling module 240 controls the power switch 300 to cut off power to the personal electrical equipment 101, and the personal electrical equipment 101 corresponding to the disconnected ZigBee module 171 whose disconnected time is greater than the default, and keeps the other electrical equipment 10 turned on.

When the ports 500n of the switch 500 corresponding to the disconnected ZigBee modules 171 whose disconnected time are higher than the default is not disconnected, in block S518, the controlling module 240 controls the power switch 300 to cut off power to the second equipment 1012 corresponding to the ZigBee modules 171 whose disconnected times are greater than the default, and keeps the other electrical equipment 10 turned on.

Step S506 shows that all ZigBee modules 171 are disconnected, but the disconnected time of the disconnected ZigBee modules 171 may be greater or less than the default. So, if not all the disconnected times are greater than the default, the controlling module 240 acts as steps S516, S518, S520 described above.

According to the embodiments and methods have been described above, the energy consumption can be decreased and the manpower costs can be saved. Besides, various embodiments and methods have been described above, it should be understood that they have been presented by way of example only and not by way of limitation. Thus the breadth and scope of the present disclosure should not be limited by the above-described embodiments, and should be at least commensurate with the following claims and their equivalents.

What is claimed is:

1. A power control device connected to a network switch with a plurality of ports, a wireless gateway connected with a plurality of wireless transmitting units, and a power switch, the power control device controlling a plurality of personal electrical equipment, the power control device comprising:
a table generating module generating a relationship table representing a relationship between the plurality of personal electrical equipment, the plurality of ports of the network switch, and the plurality of wireless transmitting units;
a detecting module receiving a port disconnected message from the network switch that indicates disconnection of the plurality of the ports, and receiving a wireless disconnected message from the wireless gateway that indicates disconnection of the plurality of the wireless transmitting units;
a timing module measuring disconnected time of the wireless transmitting units and setting a default;
a table searching module searching the relationship table to obtain the personal electrical equipment corresponding to the disconnecting ports of the network switch and the disconnecting wireless transmitting units according to the port disconnected message and the wireless disconnected message;
a determining module determining whether all wireless transmitting units are disconnected according to the wireless disconnected message and the relationship table, determining whether all the ports of the network switch are disconnected according to the port disconnected message and the relationship table, and determining whether all the disconnected times are greater than the default; and
a controlling module controlling the power switch to cut off power to the obtained personal electrical equipment based on the result of the determination of the determining module.

2. The power control device of claim 1, wherein the relationship table comprises IP addresses of the plurality of the ports, MAC addresses of the plurality of the wireless transmitting units, and numbers of personal areas representing the plurality of the personal electrical equipment.

3. The power control device of claim 1, wherein the port disconnected message comprises the IP addresses of the plurality of the ports which are disconnecting, and the wireless disconnected message comprises the MAC addresses of plurality of the wireless transmitting units which are disconnecting.

4. The power control device of claim 1, wherein the plurality of the personal electrical equipment comprises first electrical equipment and second electrical equipment, the first electrical equipment is connected to the network switch with the plurality of ports, and the second electrical equipment is not connected to the network switch.

5. The power control device of claim 4, wherein the controlling module controls the power switch to cut off power to the first electrical equipment corresponding to disconnecting ports and all the second electrical equipment when all the wireless transmitting units are disconnected, and all the disconnecting times are greater than the default and not all the ports of the network switch are disconnecting;
the controlling module controls the power switch to cut off power to all the personal electrical equipment when all the wireless transmitting units are disconnected, and all the disconnected times are greater than the default and all the ports of the network switch are disconnecting.

6. The power control device of claim 4, wherein the controlling module controls the power switch to cut off power to the second equipment corresponding to the wireless transmitting units whose disconnected times are greater than the default when not all wireless transmitting units are disconnected, and ports corresponding to the wireless transmitting units whose disconnected times are greater than the default are connecting.

7. The power control device of claim 4, wherein the controlling module also controls the power switch to cut off power to common electrical equipment on condition that power of all the second electrical equipment have been cut off.

8. The power control device of claim 1, wherein the controlling module controls the power switch to cut off power to the personal electrical equipment corresponding to the wireless transmitting units whose disconnected times are greater than the default when not all wireless transmitting units are disconnected, and ports corresponding to the wireless transmitting units whose disconnected times are greater than the default are disconnecting.

9. The power control device of claim 1, wherein the wireless transmitting units are disconnecting when the wireless gateway cannot receive radio signals sent by the wireless transmitting units, the wireless transmitting units are ZigBee modules, and the wireless gateway is a ZigBee gateway.

10. A power controlling method of a power control device which is connected to a network switch with a plurality of ports, a wireless gateway connected with a plurality of wireless transmitting units, and a power switch, the power control device controlling a plurality of personal electrical equipment, the method comprising:
generating a relationship table representing a relationship between the plurality of personal electrical equipment, the plurality of ports of the network switch, and the plurality of wireless transmitting units;
receiving a port disconnected message from the network switch that indicates disconnection of the plurality of the ports, and receiving a wireless disconnected message from the wireless gateway that indicates disconnection of the plurality of the wireless transmitting units;
measuring disconnected time of the wireless transmitting units and setting a default;
searching the relationship table to obtain the personal electrical equipment corresponding to the disconnecting ports of the network switch and the disconnecting wireless transmitting units according to the port disconnected message and the wireless disconnected message;
determining whether all wireless transmitting units are disconnected according to the wireless disconnected message and the relationship table, determining whether all the ports of the network switch are disconnected according to the port disconnected message and the relationship table, and determining whether all the disconnected times are greater than the default; and
controlling the power switch to cut off power to the obtained personal electrical equipment based on the result of the determination.

11. The method of claim 10, wherein the relationship table comprises IP addresses of the plurality of the ports, MAC addresses of the plurality of wireless transmitting units, and numbers of personal areas representing the plurality of the personal electrical equipment.

12. The method of claim 10, wherein the port disconnected message comprises the IP addresses of the ports which are disconnecting, and the wireless disconnected message comprises the MAC addresses of the wireless transmitting units which are disconnecting.

13. The method of claim 10, wherein the personal electrical equipment comprises first electrical equipment and second electrical equipment, the first electrical equipment is connected to the switch with the plurality of ports, and the second electrical equipment is not connected to the switch.

14. The method of claim 13, wherein the controlling the power switch to cut off power to the plurality of electrical equipment further comprises:
cutting off power to all the electrical equipment except for the first electrical equipment corresponding to the connecting ports when all the wireless transmitting units are disconnected, and all the disconnected times are greater than the default and not all the ports of the network switch are disconnecting;
cutting off power to all electrical equipment when all the wireless transmitting units are disconnected, and all the disconnected times are greater than the default and all the ports of the network switch are disconnecting.

15. The method of claim 13, wherein the controlling the power switch to cut off power to the plurality of personal electrical equipment further comprises:
cutting off power to the second equipment corresponding to the wireless transmitting units whose disconnected times are greater than the default when not all wireless transmitting units are disconnected, and ports corresponding to the wireless transmitting units whose disconnected times are greater than the default are connecting.

16. The method of claim 13, further comprising controlling the power switch to cut off power to the common electrical equipment upon condition that power of all the second electrical equipment have been cut off.

17. The method of claim 10, wherein controlling the power switch to cut off power to the plurality of electrical equipment further comprises:
cutting off power to the personal electrical equipment corresponding to the wireless transmitting units whose disconnected times are greater than the default when not all wireless transmitting units are disconnected, and ports corresponding to the wireless transmitting units whose disconnected times are greater than the default are disconnecting.

18. The method of claim 10, wherein the wireless transmitting units are disconnecting upon condition that the wireless gateway cannot receive radio signal sent by the wireless transmitting units, and the wireless transmitting units are ZigBee modules, the wireless gateway is a ZigBee gateway.
